(19) United States
(12) Patent Application Publication
(10) Pub. No.: US 2010/0007627 A1
(43) Pub. Date: Jan. 14, 2010

(54) Touch signal transmission circuit and liquid crystal display using the same

(75) Inventors: Hui-Lung Lai, Southern Taiwan Science Park (TW); Chen-Yen Chang, Southern Taiwan Science Park (TW)

Correspondence Address: BACON & THOMAS, PLLC, 625 SLATERS LANE, FOURTH FLOOR, ALEXANDRIA, VA, 22314-1176, US

(73) Assignee: CHI HSIN ELECTRONICS CORP., SOUTHERN TAIWAN SCIENCE PARK (TW)

(21) Appl. No.: 12/216,635

(22) Filed: Jul. 9, 2008

(51) Int. Cl. G06F 3/045

(52) U.S. Cl. 345/174

(57) ABSTRACT

A touch signal transmission circuit and an LCD using the same include an upper substrate and a plurality of first and second electrodes mounted at an inner side of the upper substrate. The first and second electrodes are arranged along a first direction and a second direction respectively, being electrically insulated with each other. Where the first and second electrodes are interlaced with each other defines touch0sensitive sections. When the user's finger touches the surface of the upper substrate, the touch-sensitive sections are touched for control or activation of the LCD. In light of this structure, the whole LCD is thinned and lightened.

### BACKGROUND OF THE INVENTION

1. Field of the Invention

The present invention relates generally to control structure of a liquid crystal display (LCD), and more particularly, to a touch signal transmission circuit and an LCD using the same.

2. Description of the Related Art

A touch-sensitive device, like a touch panel, functioning by sensing the locations that a user's finger or an object touches a panel and then transmitting signals for control or activation is the most user-friendly input device, such that it is applied to a variety of electronic products. The known touch panel principally includes resistive-type, capacitor-type, and electromagnetic-type. Among them, the resistive-type touch panel is currently the majority, but it fails to do multiple touches to have limited control. It also needs pressure for touch sensation, such that specific parts of the touch panel are subject to damage because they have to stand repeated stress for a long time. In light of this, the multi-touch capacitive-type touch panel that does not have to stand overmuch stress is more and more popular in the market.

However, even though the capacitive-type touch panel is dominant in the market, it is attached to the LCD to thicken and weight the whole panel, such that it is possible to deteriorate the optical display effect, e.g. the remittance lowers or the reflectivity rises. As for the electronic products that are developed more and more compact, there is still some space for improvement of such drawback.

### SUMMARY OF THE INVENTION

The primary objective of the present invention is to provide an LCD, whose thickness and weight can be effectively reduced on the whole.

The foregoing objective of the present invention is attained by the LCD composed of an upper substrate, a touch signal transmission circuit, a lower substrate, and a touch-sensitive integrated circuit (IC). The touch signal transmission circuit is formed at an inner side of the upper substrate, having a plurality of first electrodes and a plurality of second electrodes. The first and second electrodes are arranged along a first direction and a second direction respectively, being electrically insulated with each other. The touch signal transmission circuit includes at least one first bonding pad electrically connected with the first electrodes; and at least one second bonding pad electrically connected with the second electrodes. The lower substrate is attached to a bottom side of the upper substrate, having a plurality of lead wires. Each of the lead wires has two ends, one of which is electrically connected with the first and second bonding pads and the other is electrically connected with the touch-sensitive IC.

### BRIEF DESCRIPTION OF THE DRAWINGS

FIG. 1 is an exploded view of a first preferred embodiment of the present invention.

FIG. 2 is a perspective view of the first preferred embodiment of the present invention.

FIG. 3 is a sectional view of FIG. 2.

FIG. 4 is a perspective view of a part of the preferred embodiment of the present invention, illustrating the relationship between a touch signal transmission circuit and masking elements.

FIG. 5 is similar to FIG. 2, illustrating that a touch-sensitive IC is mounted to a flexible printed circuit board (PCB).

FIG. 6 an exploded view of a second preferred embodiment of the present invention, illustrating that two electrodes share one same bonding pad.

FIG. 7 is a perspective view of a part of the second preferred embodiment of the present invention, illustrating that the electrodes are embedded into corresponding masking elements in a predetermined interval and each of the electrodes is electrically connected with one bonding pad.

FIG. 8 is similar to FIG. 7, illustrating that two electrodes share one bonding pad.

### DETAILED DESCRIPTION OF PREFERRED EMBODIMENTS

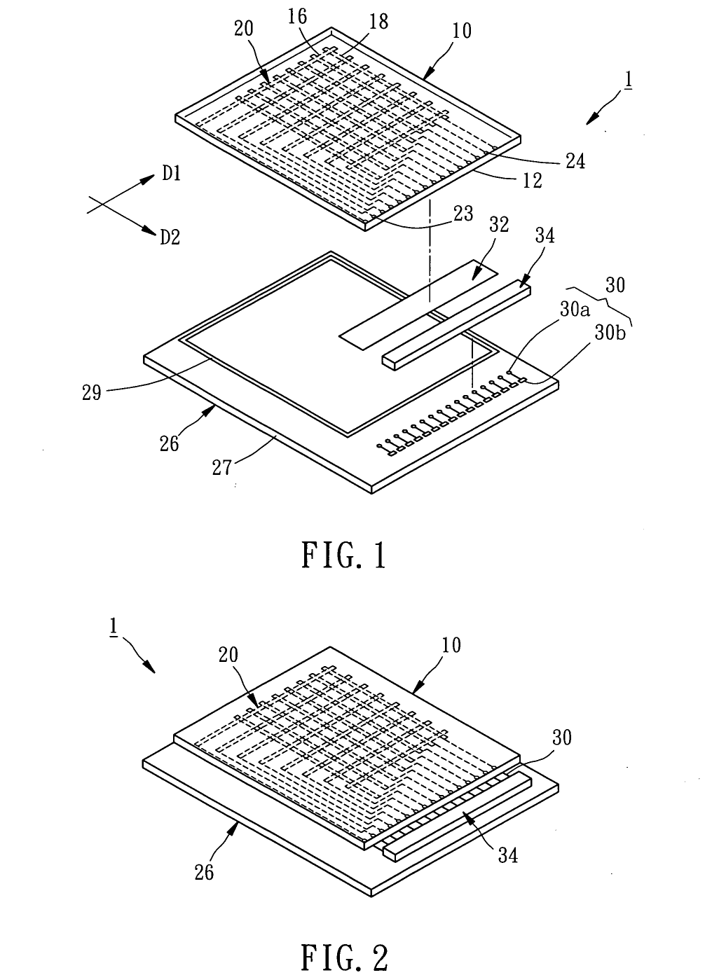

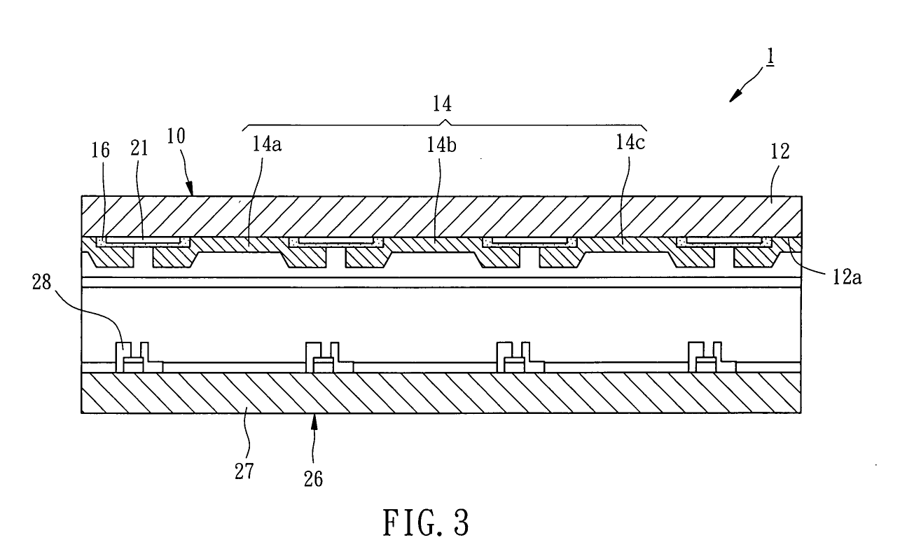

Referring to FIGS. 1-3, an LCD 1 in accordance with a preferred embodiment of the present invention is composed of an upper substrate 10, a touch signal transmission circuit 20, a lower substrate 26, a conductive layer 32, a conductive layer 32, and a touch-sensitive IC 34. The following description does not mention the manufacturing process but the structure and features only.

The upper substrate 10 includes a transparent main body 12 and a color filter 14 located at an inner side 12a of the transparent main body 12. The color filter 14 is composed of a black matrix (BM) and a plurality of red, green, blue filter units 14a, 14b, and 14c. The BM is made of black resin, having a plurality of first masking elements 16 arranged along a first direction D1; and a plurality of second masking elements 18 arranged along a second direction D2. The first direction D1 and the second direction D2 are vertically interlaced with each other. The first and second masking elements 16 and 18 define a plurality of zones, in which the red, green, and blue filter units 14a, 14b, and 14c are arranged in sequence.

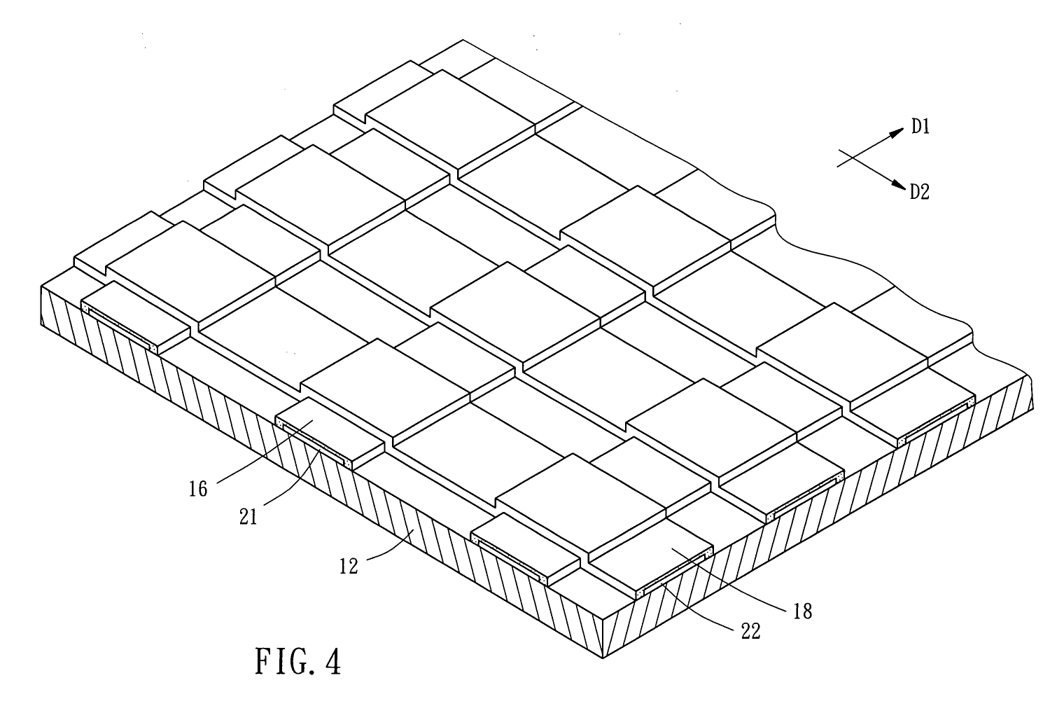

Referring to FIG. 4 in view of FIG. 1 again, the touch signal transmission circuit 20 includes a plurality of first and second electrodes 21 and 22 and a plurality of first and second bonding pads 23 and 24. The first electrodes 21 are arranged along the first direction D1 and encased by the first masking elements 16 respectively. Each of the first electrodes 21 is electrically connected with the first bonding pad 23 located close to one lateral edge of the transparent main body 12. The second electrodes 22 are arranged along the second direction D2 and encased by the second masking elements 18 respectively. Each of the second electrodes 22 is electrically connected with the second bonding pad 24 located close to one lateral edge of the transparent main body 12. It is to be noted that the second electrodes 22 are prepared after the first masking elements 16 are prepared, such that the second electrodes 22 are not electrically connected with the first electrodes 21 but stacked on the first electrodes 21 by electric insulation. Where the first and second electrodes 21 and 22 overlap each other become touch-sensitive sections of the present invention. Because the electrode is a very delicate element, there are only a few electrodes shown in the drawings to facilitate illustration and drafting the drawings.

The lower substrate 26 includes a transparent main body 27 and a plurality of film transistors 28. The transparent main body 27 is larger than the aforementioned transparent main body 12. The film transistors 28 are arranged on array on a surface of the transparent main body 27. The lower substrate 26 is attached to a bottom side of the upper substrate by a main seal 29. Where the main seal 29 is disposed is involved with the corresponding touch-sensitive sections. The transparent main body 27 of the lower substrate 26 includes a plurality of lead wires 30 located at a periphery of the main seal 29. Each of the lead wires has a first contact point 30a and a second contact point 30b at respective two ends thereof.

The conductive layer 32 is located between the upper and lower substrates 10 and 26 for electrical connection of the first and second bonding pads 23 and 24 with the first contact points 30a of the corresponding lead wires 30. In this embodiment, the conductive layer 32 is an anisotropic conductive film (ACF); alternatively, it can also be inexpensive conductive particles.

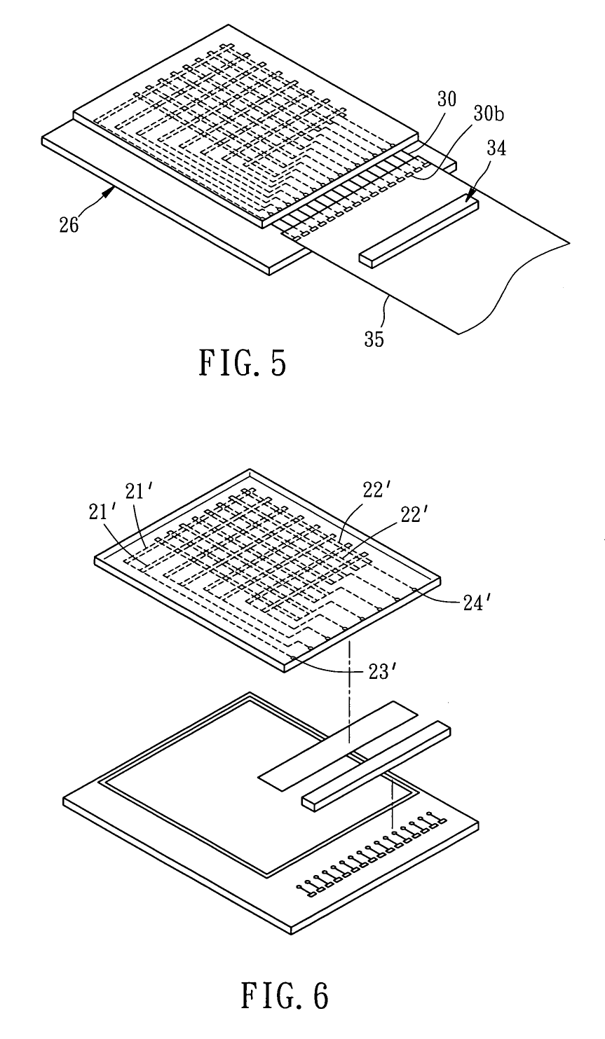

The touch-sensitive IC 34 is directly connected to the transparent main body 27 of the lower substrate 26 and electrically connected with the second contact points 30b of the lead wires 30. The touch-sensitive IC 34 is adapted for receiving signals of sensing specific locations as transmitted in the touch-sensitive sections for activation or control of the LCD 1. The touch-sensitive IC 34 can also be electrically connected to a flexible PCB 35 as shown in FIG. 5, and then the flexible PCB 35 is electrically connected with the second contact points 30b of the lead wires 30 of the lower substrate 26.

As known from the above, the primary feature of the present invention lies in that the touch signal transmission circuit 20 for touch sensation is directly prepared at the inner side 12a of the existent upper substrate 10 of the LCD 1, and meanwhile, the first and second electrodes 21 and 22 are electrically insulated with each other. Therefore, when the user's finger touches the surface of the upper substrate 10, the capacitive effect generated at where the user's finger touches is decoded for variation of the capacitance, further locating where the user's finger touches. Besides, the touch signal transmission circuit 20 is directly prepared inside the LCD 1, such that the LCD can be effectively thinned and lightened to meet the requirement that the electronic products are getting more and more compact.

FIG. 6 shows a second preferred embodiment of the present invention which is similar to but different from the first embodiment by the corresponding relationship between the first electrodes 21′ and the first bonding pads 23′ and the corresponding relationship between the second electrodes 22′ and the second bonding pads 24′ of the touch signal transmission circuit 20′ of the second embodiment, i.e. each two electrodes share one bonding pad. Alternatively, the corresponding relationship between the electrodes and the bonding pads is subject to change as it depends on the actual requirement and such change thereof does not incur imperfect touch sensation because the electrodes are densely arranged and the area that the user's finger touches is larger, thus sensing the specific locations correctly.

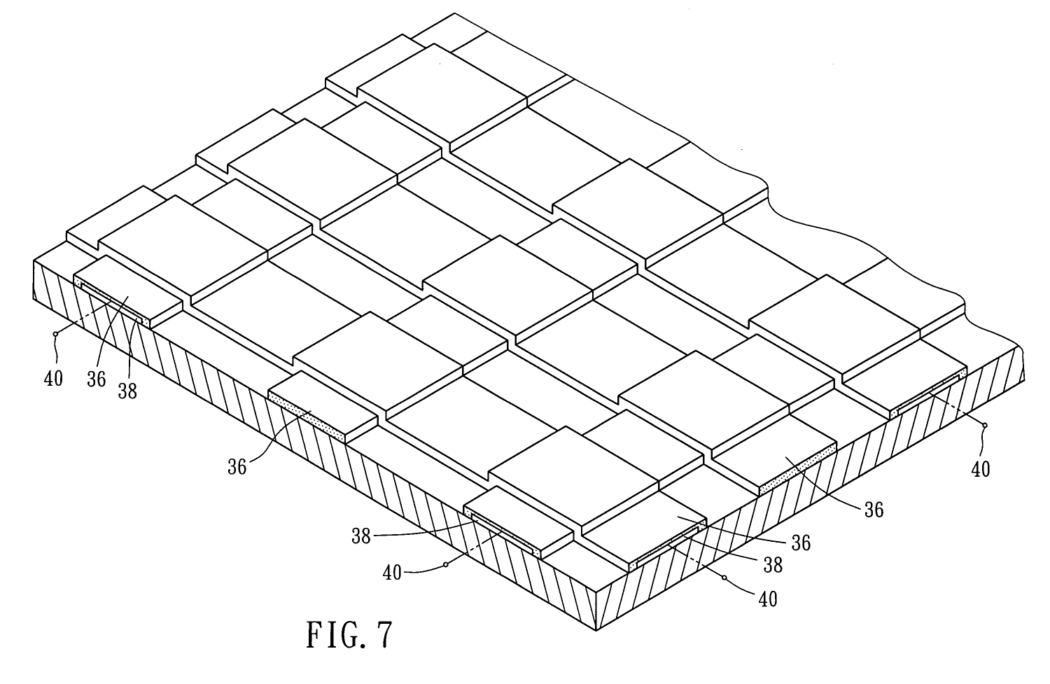

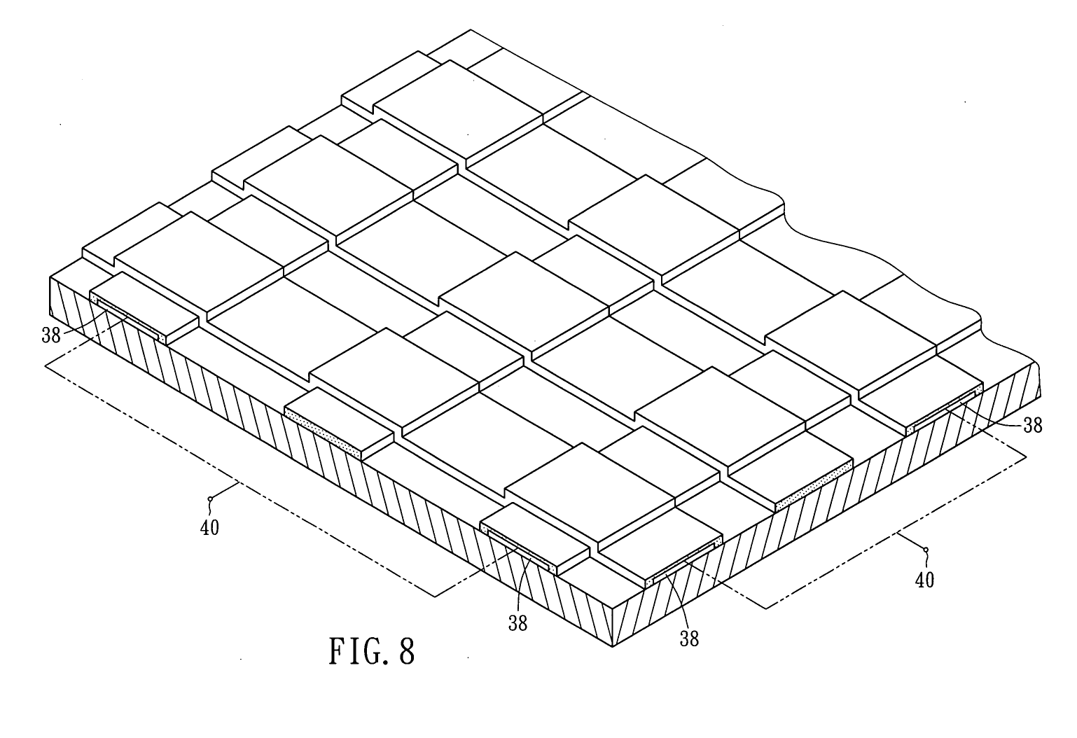

In addition, the first embodiment can have alternative structure as recited below. As shown in FIG. 7, not each of the masking elements 36 is embedded with one electrode 38 therein but the electrodes 38 are embedded into the corresponding masking elements 36 in a predetermined interval. Each of the electrodes 38 is also electrically connected with one bonding pad 40. In this way, the expense of the material that the electrode is made of can be properly reduced without deterioration of the touch-sensitive effect. Further to the structure shown in FIG. 7, the second embodiment can also have alternative structure; referring to FIG. 8, each two electrodes share one bonding pad 40.

In the above structure of the LCD, the color filter is disposed on the upper substrate and then coordinates with the common substrate of the film transistor on array. The present invention is also applicable to the LCD under the process of the color filter on array (COA), i.e. the color filter is no longer installed in the upper substrate of the LCD having the touch signal transmission circuit therein.

Although the present invention has been described with respect to specific preferred embodiments thereof, it is no way limited to the details of the illustrated structures but changes and modifications may be made within the scope of the appended claims.

What is claimed is:

1. An LCD comprising:
an upper substrate;
a touch signal transmission circuit formed at an inner side of said upper substrate, said touch signal transmission circuit having a plurality of first electrodes, a plurality of second electrodes, at least one bonding pad, and at least one bonding pad, said first electrodes being arranged along a first direction, said second electrodes being arranged along a second direction, said first and second directions being interlaced with each other, said at least one bonding pad being electrically connected with said first electrodes, said at least one bonding pad being electrically connected with said second electrodes;
a lower substrate attached to a bottom side of said upper substrate by a main seal, said lower substrate having a plurality of lead wires outside said main seal, each of said lead wires having a first contact point and a second contact point, each of said first contact points being electrically connected with corresponding ones of said at least one first and second bonding pads; and.
a touch-sensitive IC electrically connected with said second contact points of said lead wires.

2. The LCD as defined in claim 1, wherein said upper substrate comprises:
a main body; and
a color filter formed at an inner side of said main body, said color filter having a plurality of filter units and a plurality of first and second masking elements, said first masking elements being arranged along a first direction, said second masking elements being arranged along a second direction, wherein at least some of said first masking elements are embedded into said first electrodes respectively, at least some of said second masking elements are embedded into said second electrodes respectively, and said first and second masking elements are interlaced with each other to define a plurality of zones, in which corresponding ones of said filter units are mounted.

3. The LCD as defined in claim 2, wherein each of said first masking elements is embedded with one of said first electrodes therein, and each of said second masking elements is embedded with one of said second electrodes therein.

4. The LCD as defined in claim 1, wherein said first electrodes are divided into groups, each of which comprises at least two of said first electrodes and shares one of said at least one first bonding pad; said second electrodes are divided into groups, each of which comprises at least two of said second electrodes and shares one of said at least one second bonding pad.

5. The LCD as defined in claim 1, wherein said touch-sensitive IC is directly connected to said lower substrate.

6. The LCD as defined in claim 1, wherein said lower substrate is electrically connected with a flexible PCB; said second contact points of said lead wires are electrically connected with said flexible PCB; said touch-sensitive IC is electrically connected with said flexible PCB.

7. The LCD as defined in claim 1 further comprising a conductive layer located between said upper and lower substrates for electric connection of said at least one first and second bonding pads with said first contact points of said lead wires.

8. The LCD as defined in claim 7, wherein said conductive layer is an anisotropic conductive film.

9. The LCD as defined in claim 7, wherein said conductive layer comprises a plurality of conductive particles.

10. A touch signal transmission circuit mounted to an inner side of an upper substrate of an LCD, comprising:
a plurality of first electrodes arranged along a first direction;
a plurality of first bonding pads, each of which is electrically connected with at least one of said first electrodes;
a plurality of said second electrodes formed above said first electrodes by electric insulation, said second electrodes being arranged along a second direction interlaced with the first direction; and
a plurality of second bonding pads, each of which is electrically connected with at least one of said second electrodes.

11. The LCD as defined in claim 10 further comprising a plurality of first masking elements, wherein at least some of said first masking elements are embedded into said first electrodes respectively.

12. The LCD as defined in claim 11 further comprising a plurality of second masking elements, wherein at least some of said second masking elements are embedded into said second electrodes respectively.
